(19) United States
(12) Patent Application Publication
(10) Pub. No.: US 2014/0317401 A1
(43) Pub. Date: Oct. 23, 2014

(54) SERVER, SYSTEM, AND METHOD FOR ISSUING MOBILE CERTIFICATE

(71) Applicant: UNETsystem, INC., Seoul (KR)

(72) Inventors: Sang Jun LEE, Seoul (KR); Bum Chul KWON, Yongin-si (KR); Tae Hyun HAN, Seoul (KR)

(73) Assignee: UNETsystem, INC., Seoul (KR)

(21) Appl. No.: 13/871,527

(22) Filed: Apr. 26, 2013

(30) Foreign Application Priority Data
Apr. 17, 2013 (KR) 10-2013-0041927

(51) Int. Cl. H04L 9/32

(52) U.S. Cl. CPC H04L 9/3268
USPC 713/156

(57) ABSTRACT

A mobile certificate issue server, system, and method are provided. The mobile certificate issue server includes a certificate generation part for generating a certificate using a public key included in certificate issue request information received from a user terminal, an e-mail sending part for sending the certificate to an e-mail address accessible to the mobile terminal of a user, and a server-side certificate conversion part for converting the certificate into information having a recognition format capable of being recognized by the mobile terminal Here, the e-mail sending part sends the certificate through e-mail in an attachment form. The e-mail sending part stores the information having the recognition format in a file form, inserts the file into the e-mail as an attachment file, and sends the e-mail to the e-mail address accessible to the mobile terminal of the user.

### PRIORITY

This application claims the benefit under 35 U.S.C. §119(a) of a Korean patent application filed on Apr. 17, 2013 in the Korean Intellectual Property Office and assigned Serial No. 10-2013-0041927, the entire disclosure of which is hereby incorporated by reference.

### BACKGROUND OF THE INVENTION

1. Field of the Invention

The present invention relates to a server, system, and method for issuing a mobile certificate.

2. Description of the Related Art

In general, a method of storing a certificate in a mobile terminal includes a process of accessing a certificate issue server through a PC, storing the certificate in the PC through a series of certificate issues processes, connecting the PC to a mobile terminal, and storing the certificate stored in the PC in the mobile terminal.

Korean Patent Laid-Open Publication No. 10-2011-0057376 (entitled ‘A Method of Transporting Certificate to Mobile Terminal’ disclosed on Jun. 1, 2011, hereinafter referred to as ‘the prior art’) discloses a method of transporting a certificate to a mobile terminal.

However, the prior art relates to a method of encrypting a certificate located in a user fixed terminal PC and sending the encrypted certificate to a mobile terminal and has a problem in that a user fixed terminal PC must be used.

Here, the reason why the mobile terminal and the certificate issue server cannot be directly coupled and a certificate cannot be issued and stored between the mobile terminal and the certificate issue server is that the Operating System (OS) of the mobile terminal prevents the issued certificate from being directly stored in the OS storage of the mobile terminal for a reason of security.

That is, a method of distributing a certificate over a current common PC based on Windows is problematic in that the certificate cannot be directly distributed over a mobile OS.

Accordingly, there is a need for the development of technology in which a certificate can be distributed into a mobile terminal through direct connection between a certificate issue server and the mobile terminal not the method of issuing a certificate between the certificate issue server and a common PC and transporting the certificate stored in the PC to a mobile terminal.

### SUMMARY OF THE INVENTION

Aspects of the present invention are to address at least the above-mentioned problems and/or disadvantages and to provide at least the advantages described below. Accordingly, an aspect of the present invention is to provide technology in which a certificate can be issued and distributed through direct connection between a mobile terminal and a mobile certificate issue server.

In accordance with an aspect of the present invention, a mobile certificate issue server is provided. The mobile certificate issue server includes a certificate generation part for generating a certificate using a public key included in certificate issue request information received from a user terminal and an e-mail sending part for sending the generated certificate to an e-mail address accessible to a mobile terminal of a user, wherein the e-mail sending part sends the certificate through e-mail in an attachment form.

The mobile certificate issue server may further include a server-side certificate conversion part for converting the generated certificate into information having a recognition format capable of being recognized by the mobile terminal. The e-mail sending part may store the information having the recognition format in a file form, insert the file into the e-mail as an attachment file, and send the e-mail to the e-mail address accessible to the mobile terminal of the user.

Furthermore, the recognition format may be a Personal inFormation eXchange (PFX) file format.

Furthermore, the mobile certificate issue server may further include a member information confirmation part for performing user authentication based on a user ID/PW received from the user terminal and requesting the user terminal to generate a public key/private key pair.

In accordance with another aspect of the present invention, a mobile certificate issue system is provided. The mobile certificate issue system includes a user terminal for requesting to generate and issue a certificate by entering an ID/PW; a mobile certificate issue server for receiving the request to generate and issue the certificate from the user terminal, generating the certificate, and sending the generated certificate to an e-mail address designated by a user; and a mobile terminal for accessing the e-mail address, wherein the mobile certificate issue server attaches the generated certificate to e-mail and sending the e-mail to the e-mail address.

Here, the user terminal may include a member information input part for receiving the ID/PW and certificate private key password for authenticating the user from the user; a key generation part for generating a public key/private key pair using the private key password and requesting the mobile certificate issue server to generate the certificate by sending the generated public key/private key pair to the mobile certificate issue server; and a terminal-side certificate conversion part for converting the certificate into information having a recognition format capable of being recognized by the mobile terminal using the private key generated by the key generation part and the certificate received from the mobile certificate issue server and sending the information having the recognition format to the mobile certificate issue server.

Furthermore, the mobile certificate issue server may include a member information confirmation part for authenticating the user based on the ID/PW and certificate private key password received from the member information entry part and requesting the key generation part to generate the public key/private key pair; a certificate generation part for generating the certificate using the public key/private key pair received from the key generation part; and an e-mail sending part for sending the generated certificate to the e-mail address accessible to the mobile terminal of the user.

The mobile certificate issue server may further include a server-side certificate conversion part for converting the generated certificate into information having a recognition format capable of being recognized by the mobile terminal. The e-mail sending part may store the information having the recognition format, converted by the server-side certificate conversion part or the terminal-side certificate conversion part, in a file form, insert the file into the e-mail as an attachment file, and send the e-mail to the e-mail address accessible to the mobile terminal of the user.

In accordance with yet another aspect of the present invention, a mobile certificate issue method is provided. The mobile certificate issue method includes a first step of executing a terminal client application program in a user terminal and connecting the user terminal to a mobile certificate issue server; a second step of the mobile certificate issue server receiving user information, comprising a private key password, from the user terminal; a third step of the mobile certificate issue server requesting the user terminal to generate a public key/private key pair after the user is successfully authenticated using the user information; a fourth step of the user terminal generating the public key/private key pair, encrypting the private key using the private key password, and temporarily storing the encrypted private key; a fifth step of the user terminal inserting the generated public key into information having a Certificate Signing Request (CSR) form and sending the information to the mobile certificate issue server; a sixth step of the mobile certificate issue server generating a certificate using the CSR; a seventh step of the mobile certificate issue server or the user terminal generating information having a Personal inFormation eXchange (PFX) form using the encrypted private key and the generated certificate; an eighth step of storing the generated PFX information in the mobile certificate issue server; and a ninth step of the mobile certificate issue server attaching the PFX information to e-mail in an attachment file form and sending the e-mail to an e-mail address of the user accessible to the mobile terminal.

Here, the mobile terminal may store the certificate in the Operating System (OS) storage of the mobile terminal when the PFX information including the certificate that is attached to the e-mail is executed.

Furthermore, at the fifth step, the user terminal may send both the information having the CSR form and the encrypted private key to the mobile certificate issue server if a certificate for a mobile OS not supporting PFX is sought to be generated. If a certificate for a mobile OS supporting PFX is sought to be generated, the certificate generated at the sixth step may be transmitted to a terminal-side certificate conversion part of the user terminal If a certificate for a mobile OS not supporting PFX is sought to be generated, the certificate generated at the sixth step may be transferred to a server-side certificate conversion part of the mobile certificate issue server and the certificate and the encrypted private key may be converted into a format capable of being accommodated into the mobile OS.

The mobile certificate issue method may further include a tenth step of the mobile terminal executing the PFX certificate attached to the e-mail received from the mobile certificate issue server and storing the certificate of an OS storage of the mobile terminal

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a mobile certificate issue server and system according to an exemplary embodiment of the present invention.

FIG. 2 is a flowchart illustrating a method for issuing a mobile certificate according to an exemplary embodiment of the present invention.

Throughout the drawings, it should be noted that like reference numbers are used to depict the same or similar elements, features, and structures.

### DESCRIPTION OF REFERENCE NUMERALS OF PRINCIPAL ELEMENTS IN THE DRAWINGS

10: user terminal

11: member information entry part

12: key generation part

13: terminal-side certificate conversion part

20: mobile certificate issue server

21: member information confirmation part

22: certificate generation part

23: server-side certificate conversion part

24: e-mail sending part

30: mobile terminal

31: e-mail client

32: e-mail check part

33: OS PFX import part

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms or words used in this specification and claims should not be construed as having common or dictionary meanings, but should be construed as having meanings and concepts that comply with the technical spirit of the present invention on the basis of a principle that the inventor can appropriately define the concepts of the terms in order to describe his or her invention in the best way.

It is to be understood that the singular forms “a,” “an,” and “the” include plural referents unless the context clearly dictates otherwise. Thus, for example, reference to “a component surface” includes reference to one or more of such surfaces.

Accordingly, the embodiments described in this specification and elements shown in the drawings illustrate only exemplary embodiments of the present invention and do not represent the entire technical spirit of the present invention. Accordingly, it should be understood that a variety of equivalents and modifications capable of replacing the embodiments and the constructions may exist at the time of filing of this application.

Furthermore, prior to a detailed description, the detailed elements of a certificate issue request unit and a mobile certificate issue server include elements for performing communication, information storage, authentication, control, and processing with other elements that form a system. It is however to be noted that a description of the detailed elements other than essential elements including the technical spirit of the present invention is omitted in order to clarify a description of the prevent invention.

### 1. Description of a Mobile Certificate Issue Server and a Mobile Certificate Issue System

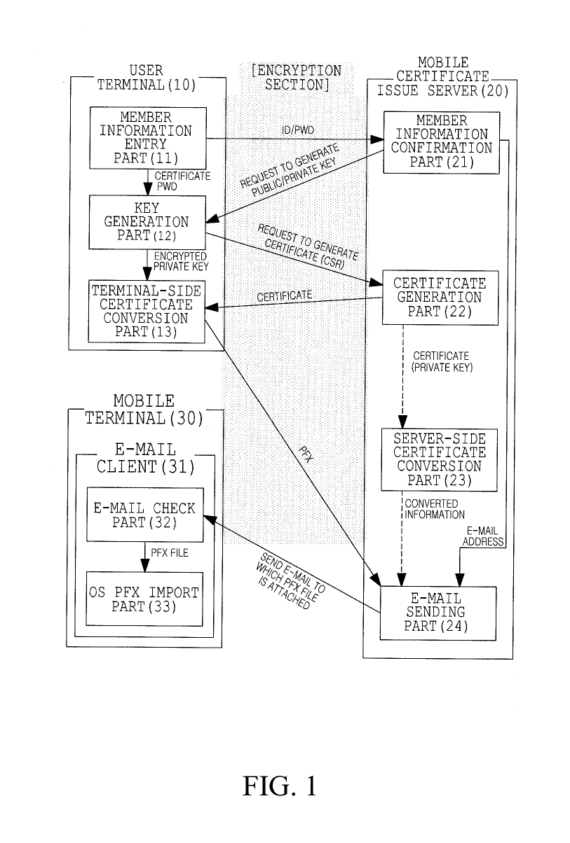

FIG. 1 is a block diagram of the mobile certificate issue server and system according to an exemplary embodiment of the present invention.

A network section between a mobile certificate issue server 20 and a user terminal 10 must maintain security through communication using an SSL method or an encryption method using an encryption library. The user terminal 10 may be a PC or a mobile device.

Referring to FIG. 1, the mobile certificate issue server 20 in accordance with the present invention includes a member information confirmation part 21, a certificate generation part 22, a server-side certificate conversion part 23, and an e-mail sending part 24.

The member information confirmation part 21 authenticates a user using a user's ID/PWD and requests the user terminal 10 to generate a public key/private key. Furthermore, the member information confirmation part 21 provides the e-mail address of the user to the e-mail sending part 24.

The certificate generation part 22 generates a certificate using a Certificate Generation Request (CSR) received from the key generation part 12 of the user terminal 10. If a certificate for a mobile terminal that does not support PFX is sought to be generated, the certificate generation part 22 receives an encrypted private key along with the CSR and stores them.

The server-side certificate conversion part 23 is used only when a certificate for a mobile terminal that does not support PFX is sought to be generated. The server-side certificate conversion part 23 receives the certificate and the encrypted private key from the certificate generation part 22 and converts the certificate and the encrypted private key into a format (e.g., XML) that can be accommodated in a mobile OS.

The e-mail sending part 24 generates e-mail, converts information having a PFX form, received from the terminal-side certificate conversion part 13 of the user terminal 10, into an attachment file form, and sends the generated e-mail containing the attachment file to the e-mail address of the user received from the member information confirmation part 21. If a certificate for a mobile terminal not supporting PFX is sought to be generated, the e-mail sending part 24 receives format information that can be accommodated in a mobile OS from the server-side certificate conversion part 23, converts the formation information into an attachment file, and sends e-mail including the attachment file.

The certificate can be issued and distributed when the mobile terminal 30 executes the attachment file included in a received e-mail.

Meanwhile, the mobile certificate issue system in accordance with the present invention includes the user terminal 10, the mobile certificate issue server 20, and the mobile terminal 30.

The user terminal 10 may be a PC or a mobile device. It is to be noted that the user terminal 10 and the mobile terminal 30 may be provided as the same terminal, such as a smart phone or a tablet PC, but they are independent elements in order to clarify the elements in the expressions of FIG. 1 and the following description.

The user terminal 10 includes the member information entry part 11, the key generation part 12, and the terminal-side certificate conversion part 13.

The user terminal 10 is connected to the mobile certificate issue server 20 and configured to request the mobile certificate issue server 20 to issue a certificate.

The member information entry part 11, the key generation part 12, and the terminal-side certificate conversion part 13 can be provided in the form of a certificate issue request application or a Hyper Text Markup Language 5 (TML5) browser that is installed in a PC or a mobile device.

The HTML5 browser can be used when an HTML5 web crypto Application Programming Interface (API) that is being standardized is adopted. In this case, a certificate can be issued and distributed without installing an additional application (e.g., a certificate issue request application) in a mobile terminal. If a browser that supports the HTML5 web API is included in any new mobile OS, a certificate can be applied, issued, and distributed even without installing an additional application.

Furthermore, the member information entry part 11 receives an input value for authenticating a user from the member information confirmation part 21 of the mobile certificate issue server 20. Here, essentially received information includes a user ID/PWD and a password that will be used in a certificate to be generated. The certificate password is used when the key generation part 12 encrypts a private key.

The key generation part 12 generates a public key/private key pair when a user is authenticated by the member information confirmation part 21 of the mobile certificate issue server 20 and a request to generate a public key/private key is received from the member information confirmation part 21. The key generation part 12 encrypts the generated private key using the certificate password, temporarily stores the encrypted private key, generates a Certificate Signing Request (CSR), that is, a certificate generation request, using the public key, and sends the CSR to the certificate generation part 22 of the mobile certificate issue server 20. If a certificate for a mobile terminal not supporting PFX is sought to be generated, the key generation part 12 sends the encrypted private key along with the CSR to the certificate generation part 22 so that the server-side certificate conversion part 23 of the mobile certificate issue server 20 can generate converted information.

The terminal-side certificate conversion part 13 of the user terminal 10 generates information having a PFX form at using the certificate received from the certificate generation part 22 of the mobile certificate issue server 20 and the encrypted private key received from the key generation part 12. If a certificate for a mobile terminal not supporting PFX is sought to be generated, the terminal-side certificate conversion part 13 is not used.

An e-mail client 31 mounted on the mobile terminal 30 checks e-mail transmitted by the e-mail sending part 24 of the mobile certificate issue server 20. The e-mail client 31 includes an e-mail check part 32 and an OS PFX import part 33. The e-mail client 31 can have a dedicated e-mail client App form or a mobile web mail form.

The e-mail check part 32 checks e-mail that is received from a user through the e-mail sending part 24 of the mobile certificate issue server 20 using the e-mail client 31. The e-mail contains an attachment file having a PFX form. If a certificate for a mobile terminal not supporting PFX is sought to be generated, e-mail contains an attachment file having a format that can be accommodated in a mobile OS.

An import App that is basically executed by an OS when a user attempts to open e-mail containing an attachment file is executed in the OS PFX import part 33. A certificate is stored in the OS storage through the import App. If a certificate for a mobile terminal not supporting PFX is sought to be generated, the certificate is stored in the OS storage because the certificate has a format that can be accommodated in a mobile OS. Since the certificate is stored in the OS storage, the certificate is recognized by an application that tries to use the certificate according to a standard method. For example, in a WLAN certification process (RADIUS certification process), if a certificate necessary to set Transport Layer Security (TLS) certification is issued by the mobile certificate issue server and system in accordance with the present invention, a certificate necessary for the security of the transport layer can be recognized.

Meanwhile, the user terminal 10 and the mobile certificate issue server 20 perform their roles using an encryption library. A public key and a private key are generated based on PKCS #1 using the encryption library. Information having a Certificate Signing Request (CSR) form is generated. The public key is inserted into the CSR form, and the private key is generated in a private-key information syntax standard (PKCS #8) form. The private key generated in the private-key information syntax standard (PKCS #8) form is encrypted in a password-based cryptography standard (PKCS #5) form and used to convert a certificate into a PFX form.

An RSA cryptography standard (PKCS #1) defines mathematical properties and rules for an RSA public key and secret key. Furthermore, the RSA cryptography standard defines algorithms and rules, such as encoding/padding, which are necessary for RSA encryption and decryption and the implementation of signature verification.

The private-key information syntax standard (PKCS #8) is one of public key cryptography standards proposed by RSA Co., The private-key information syntax standard (PKCS #8) includes a private key and attribute information for a public key algorithm and defines a syntax for an encrypted private key.

The password-based cryptography standard (PKCS #5) is one of public key password standards proposed by RSA Co., The password-based cryptography standard (PKCS #5) describes a method of encrypting private key information based on a user's password and encrypts a private key when the private key is sent over a network.

### 2. Description of Method

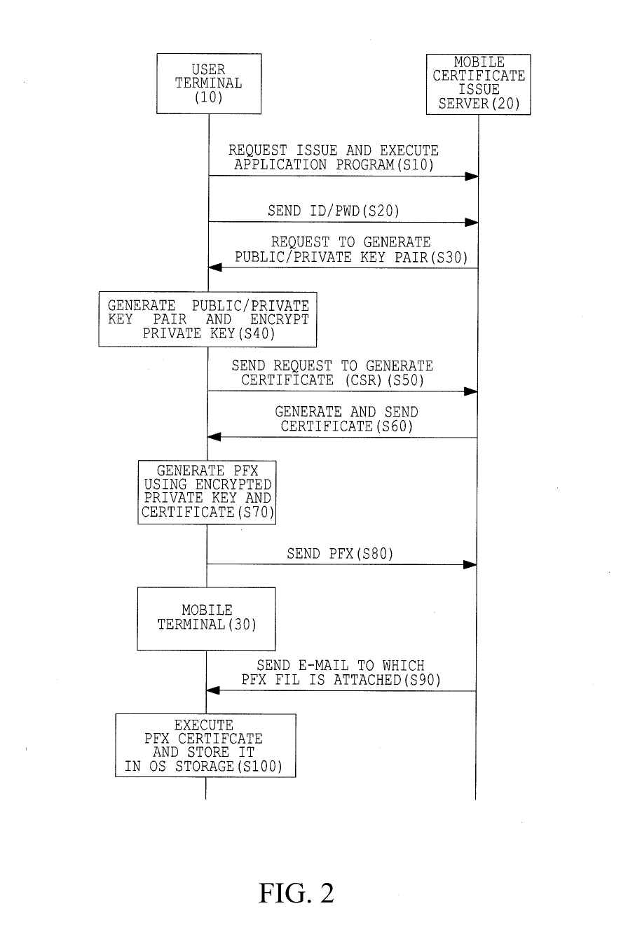

FIG. 2 is a flowchart illustrating a method for issuing a mobile certificate according to an exemplary embodiment of the present invention.

Referring to FIG. 2, the method for issuing a mobile certificate in accordance with the present invention includes a first step S10 in which the user terminal 10 executes a terminal client application program in order to issue a mobile certificate; a second step S20 in which the user terminal 10 receives an ID/PWD from a user in order to authenticate the user and sends the ID/PWD to the mobile certificate issue server 20; a third step S30 in which the mobile certificate issue server 20 requests the terminal client of the user terminal 10 to generate a public key/private key pair after the user is authenticated; a fourth step S40 in which the user terminal 10 generates the public key/private key pair, encrypts the private key using a private key password, and temporarily stores the encrypted private key; a fifth step S50 in which the user terminal 10 inserts the generated public key into information having a CSR form and sends the information to the mobile certificate issue server 20; a sixth step S60 in which the mobile certificate issue server 20 generates a certificate using the CSR and sends the generated certificate to the terminal client of the user terminal 10; a seventh step S70 in which the terminal client of the user terminal 10 generates information having a PFX form using the encrypted private key and the certificate; an eighth step S80 in which the terminal client of the user terminal 10 sends the generated PFX information to the mobile certificate issue server 20; a ninth step S90 in which the mobile certificate issue server 20 inserts the PFX information into e-mail in an attachment file form and sends the e-mail to the user; and a tenth step S100 in which the user checks the e-mail using the mobile terminal 30, executes the attached PFX file, and stores the certificate in the OS storage of the mobile terminal 30.

1) Execute Issue Request Application Program (the First Step, S10)

The terminal client application program installed in the user terminal 10 is executed and thus the user terminal 10 is able to communicate with the mobile certificate issue server 20. The terminal client can be a PC or a mobile device and can be provided in the form of a certificate issue request application or Hyper Text Markup Language 5 (HTML5) browser.

2) Send ID/PWD (the Second Step, S20)

For user authentication, a user enters an ID/PWD and a private key password. The ID/PWD are transmitted to the mobile certificate issue server 20, and the private key password is temporarily stored in order to be used in the step S40 of generating a public key/private key and encrypting the private key.

3) Request to Generate Public Key/Private Key Pair (the Third Step, S30)

If the user is authenticated using the ID/PWD, the mobile certificate issue server 20 requests the terminal client of the user terminal 10 to generate a public key/private key pair.

4) Generate Public Key/Private Key and Encrypt Private Key (the Fourth Step, S40)

The terminal client of the user terminal 10 generates the public key/private key pair, encrypts the private key using the private key password, and stores the encrypted private key. The private key is generated in a private-key information syntax standard (PKCS #8) form and then encrypted in a password-based cryptography standard (PKCS #5) form.

5) Send Certificate Generation Request (CSR) (the Fifth Step, S50)

The terminal client of the user terminal 10 inserts the public key, generated in the step S40 of generating the public key/private key and encrypting the private key, into information having a Certificate Signing Request (CSR) form and sends the CSR to the mobile certificate issue server 20. If a certificate for a mobile OS not supporting PFX is sought to be generated, the CSR form is transmitted along with the encrypted private key.

6) Generate and Send Certificate (the Sixth Step, S60)

The mobile certificate issue server 20 generates a certificate using the CRS generated at step S50 and sends the generated certificate to the terminal client of the user terminal 10. If a certificate for a mobile OS not supporting PFX is sought to be generated, the certificate is not transmitted to the terminal client of the user terminal 10 after the certificate is generated. Instead, the certificate and the encrypted private key are converted into a format (e.g., XML) that can be accommodated into the mobile OS and then inserted into e-mail in the form of an attachment file, and the e-mail is transmitted.

7) Generate PFX Using Encrypted Private Key and Certificate (the Seventh Step, S70)

The terminal client of the user terminal 10 generates information having a Personal inFormation eXchange (PFX) form using the received certificate and the temporarily stored encrypted private key. If a certificate for a mobile OS not supporting PFX is sought to be generated, this step is omitted.

8) Send PFX (the Eighth Step, S80)

The terminal client of the user terminal 10 sends the generated PFX information to the mobile certificate issue server 20. If a certificate for a mobile OS not supporting PFX is sought to be generated, this step is omitted.

9) Send PFX E-Mail Attachment File (the Ninth Step, S90)

The mobile certificate issue server 20 produces the PFX information received from the terminal client of the user terminal 10 into a file, inserts the file into e-mail as an attachment file, and sends the e-mail to the e-mail address of the user. If a certificate for a mobile OS not supporting PFX is sought to be generated, the PFX information is formed into the format (e.g., XML) capable of being accommodated into a mobile OS, which has been generated at step S60 and inserted into e-mail in the form of an attachment file, and the e-mail is transmitted.

10) Execute PFX Certificate and Store Certificate in OS Storage (the Tenth Step, S100)

The user checks his or her e-mail and executes the attachment file attached to the e-mail. When the attachment file is executed, an import App basically supported by the mobile OS is executed, and the import App stores the certificate/private key information in the certificate storage of the mobile OS.

As described above, the mobile certificate issue server, system, and method according to the present invention can have the following advantages.

First, a certificate can be issued and distributed through direct connection between a mobile terminal and the mobile certificate issue server although a function of storing a certificate limited by the security of a mobile terminal OS is detoured or an expedient method is not.

Second, since information about a private key is transmitted in an encrypted form, the mobile certificate issue server is unable to know the information about a private key and thus security related to a basis certificate issue is not violated.

Third, if the HTML5 web crypto API now being standardized is used, a certificate can be issued and distributed without distributing an additional application over a mobile terminal

Fourth, the present invention can be added to an existing PC certificate distribution method in addition to a mobile terminal, and the present invention can replace an existing PC certificate distribution method.

Fifth, a certificate can be directly recognized by an application trying to use the certificate according to a standard method because it is stored in the OS storage of a mobile terminal and. Accordingly, generality can be improved.

While the invention has been shown and described with reference to certain exemplary embodiments thereof, it will be understood by those skilled in the art that various in form and details may be made therein without departing from the spirit and scope of the invention as defined by the appended claims and their equivalent.

What is claimed is:

1. A mobile certificate issue server, comprising:
a certificate generation part for generating a certificate using a public key included in certificate issue request information received from a user terminal; and
an e-mail sending part for sending the generated certificate to an e-mail address accessible to a mobile terminal of a user,
wherein the e-mail sending part sends the certificate through e-mail in an attachment form.

2. The mobile certificate issue server of claim 1, further comprising a server-side certificate conversion part for converting the generated certificate into information having a recognition format capable of being recognized by the mobile terminal,
wherein the e-mail sending part stores the information having the recognition format in a file form, inserts the file into the e-mail as an attachment file, and sends the e-mail to the e-mail address accessible to the mobile terminal of the user.

3. The mobile certificate issue server of claim 2, wherein the recognition format is a Personal inFormation eXchange (PFX) file format.

4. The mobile certificate issue server of claim 1, further comprising a member information confirmation part for performing user authentication based on a user ID/PW received from the user terminal and requesting the user terminal to generate a public key/private key pair.

5. A mobile certificate issue system, comprising:
a user terminal for requesting to generate and issue a certificate by entering an ID/PW;
a mobile certificate issue server for receiving the request to generate and issue the certificate from the user terminal, generating the certificate, and sending the generated certificate to an e-mail address designated by a user; and
a mobile terminal for accessing the e-mail address,
wherein the mobile certificate issue server attaches the generated certificate to e-mail and sending the e-mail to the e-mail address.

6. The mobile certificate issue system of claim 5, wherein the user terminal comprises:
a member information input part for receiving the ID/PW and certificate private key password for authenticating the user from the user;
a key generation part for generating a public key/private key pair using the private key password and requesting the mobile certificate issue server to generate the certificate by sending the generated public key/private key pair to the mobile certificate issue server; and
a terminal-side certificate conversion part for converting the certificate into information having a recognition format capable of being recognized by the mobile terminal using the private key generated by the key generation part and the certificate received from the mobile certificate issue server and sending the information having the recognition format to the mobile certificate issue server.

7. The mobile certificate issue system of claim 6, wherein the mobile certificate issue server comprises:
a member information confirmation part for authenticating the user based on the ID/PW and certificate private key password received from the member information entry part and requesting the key generation part to generate the public key/private key pair;
a certificate generation part for generating the certificate using the public key/private key pair received from the key generation part; and
an e-mail sending part for sending the generated certificate to the e-mail address accessible to the mobile terminal of the user.

8. The mobile certificate issue system of claim 7, wherein:
the mobile certificate issue server further comprises a server-side certificate conversion part for converting the generated certificate into information having a recognition format capable of being recognized by the mobile terminal, and
the e-mail sending part stores the information having the recognition format, converted by the server-side certificate conversion part or the terminal-side certificate conversion part, in a file form, inserts the file into the e-mail as an attachment file, and sends the e-mail to the e-mail address accessible to the mobile terminal of the user.

9. A mobile certificate issue method, comprising:
a first step of executing a terminal client application program in a user terminal and connecting the user terminal to a mobile certificate issue server;
a second step of the mobile certificate issue server receiving user information, comprising a private key password, from the user terminal;
a third step of the mobile certificate issue server requesting the user terminal to generate a public key/private key pair after the user is successfully authenticated using the user information;
a fourth step of the user terminal generating the public key/private key pair, encrypting the private key using the private key password, and temporarily storing the encrypted private key;
a fifth step of the user terminal inserting the generated public key into information having a Certificate Signing Request (CSR) form and sending the information to the mobile certificate issue server;
a sixth step of the mobile certificate issue server generating a certificate using the CSR;
a seventh step of the mobile certificate issue server or the user terminal generating information having a Personal inFormation eXchange (PFX) form using the encrypted private key and the generated certificate;
an eighth step of storing the generated PFX information in the mobile certificate issue server; and
a ninth step of the mobile certificate issue server attaching the PFX information to e-mail in an attachment file form and sending the e-mail to an e-mail address of the user accessible to the mobile terminal.

10. The mobile certificate issue method of claim 9, wherein the mobile terminal stores the certificate in an Operating System (OS) storage of the mobile terminal when the PFX information including the certificate that is attached to the e-mail is executed.

11. The mobile certificate issue method of claim 9, wherein:
at the fifth step, the user terminal sends both the information having the CSR form and the encrypted private key to the mobile certificate issue server if a certificate for a mobile OS not supporting PFX is sought to be generated,
if a certificate for a mobile OS supporting PFX is sought to be generated, the certificate generated at the sixth step is transmitted to a terminal-side certificate conversion part of the user terminal, and
if a certificate for a mobile OS not supporting PFX is sought to be generated, the certificate generated at the sixth step is transferred to a server-side certificate conversion part of the mobile certificate issue server and the certificate and the encrypted private key are converted into a format capable of being accommodated into the mobile OS.

12. The mobile certificate issue method of claim 9, further comprising a tenth step of the mobile terminal executing the PFX certificate attached to the e-mail received from the mobile certificate issue server and storing the certificate of an OS storage of the mobile terminal
